(19) United States
(12) Patent Application Publication
(10) Pub. No.: US 2019/0299494 A1
(43) Pub. Date: Oct. 3, 2019

(54) MICROWAVE WELDING OF ELASTOMER POWDER

(71) Applicant: BASF SE, Ludwigshafen am Rhein (DE)

(72) Inventors: Frank PRISSOK, Lemfoerde (DE); Michael HARMS, Lemfoerde (DE)

(73) Assignee: BASF SE, Ludwigshafen am Rhein (DE)

(21) Appl. No.: 16/318,297

(22) PCT Filed: Jul. 20, 2017
(86) PCT No.: PCT/EP2017/068396

§ 371 Date: Jan. 16, 2019

(30) Foreign Application Priority Data
Jul. 21, 2016 (EP) 16180469.5

(51) Int. Cl. B29C 35/08; B29B 7/00; B29B 9/06; B29C 41/46; B29C 64/153; B29B 7/06; B29B 7/48; B29B 7/90; B29C 41/00; B29C 41/04; B29C 41/18; C08K 5/06; C08K 5/11

(52) U.S. Cl. CPC B29C 35/0805; B29B 7/005; B29B 9/065; B29C 41/46; B29C 64/153; B29B 7/06; B29K 2075/00; B29B 7/90; B29C 41/003; B29C 41/04; B29C 41/18; C08K 5/06; C08K 5/11; B29B 7/484

(57) ABSTRACT

A process for producing moldings from a powder based on
thermoplastic elastomers, wherein the powder is placed on a mold or in a mold and by means of electromagnetic radiation is heated to an extent such that the powder undergoes at least partial melting and thus fuses to afford the molding and the frequency of the electromagnetic radiation is between 0.01 GHz and 300 GHz.

The present invention relates to a production process for moldings based on powder based on thermoplastic elastomers, wherein the powder is heated by electromagnetic radiation and thus welded to afford the molding. The invention further relates to moldings produced by this process and to thermoplastic elastomer powders and the use thereof which are suitable for the production of these moldings.

### PRIOR ART

Powders based on elastomers are according to the prior art processed into moldings by the powder slush process, such as is described for example in DE3916874, DE4006648 and in DE4107454, or the rotational sintering process such as is disclosed for example in DE 102007019862 A1 by application onto a hot metal mold.

To this end the molds are heated in a first step, for example in an oven, by infrared radiation or using gas burners. The temperature of the molds must be sufficiently high for the thermoplastic elastomer powder added in the following step to undergo at least partial melting at the hot wall so that it can sinter together, thus affording a stable molded article.

In a further step the metal mold must be cooled again to an extent such that the elastomer solidifies and the molding can be removed.

To produce a further molding the mold must once again be heated to above the melting point of the thermoplastic elastomer powder.

The heating and cooling times make this process very protracted.

Since, as a result of the repeated heating and cooling of the typically massive metal molds the energy consumption is very high, alternative production processes have long been sought for reasons of energy saving. For example DE 40 06 648 A1 describes the production of Cellular polyurethanes not only via heating of the molds in ovens but also via surficial heat radiation.

Compact thermoplastic elastomers are typically produced by extrusion or injection molding. Both processes use thermoplastic pellet material as the starting material for manufacturing component parts. Injection molding requires molds which are complex to construct, inflexible and costly. In contrast to injection molding, extrusion can readily be used to mass-produce thin films but, in contrast to the powder slush process, the film thickness cannot be flexibly altered and only 2-dimensional structured component parts may be produced.

The present invention accordingly has for its object to overcome the disadvantages of the described processes and to provide a better process.

### DESCRIPTION

This is surprisingly accomplished when moldings are produced from a powder based on thermoplastic elastomers, preferably thermoplastic polyurethane, wherein the powder is placed on a mold or in a mold and by means of electromagnetic radiation is heated to an extent such that the powder undergoes at least partial melting and thus fuses to afford the molding, wherein the frequency of the electromagnetic radiation is between 0.01 GHz and 300 GHz, preferably between 0.01 GHz and 100 GHz, particularly preferably 0.1 GHz and 50 GHz.

In preferred embodiments the electromagnetic waves are used by means of drift tubes, such as klystrons, traveling wave tubes or magnetrons, Gunn diodes for fixed frequencies. In other preferred embodiments backward-wave oscillators are used for large frequency ranges or masers for the targeted irradiation and heating of individual regions and/or layers of the moldings.

The penetration of the electromagnetic radiation in this frequency range, which is not possible in the case of sintering on hot molds, allows a rapid, specific and precisely controllable heating of the elastomer powder and thus a rapid controlled sintering together without the heat needing to slowly pass from the outside inward. Thus also possible is layerwise sintering of a layer of thermoplastic elastomer powder onto thermally nonconducting microwave-resistant solid substrates or flexible fabrics.

A further advantage of the process compared to the customary process is that the molds no longer need to be thermally conducting nor require a high heat capacity to store the melting energy. Metal molds may therefore be eschewed.

Preferably used instead are high temperature resistant polymer material, ceramics or glass having no microwave absorption. These materials are known for example as materials for microwave crockery.

The use of plastics molds allows the described process to provide a very cost-effective alternative for the production of low production numbers since the production costs of the molds are markedly low compared to metal molds.

Coloring of the elastomer powder additionally allows for a very wide variety of designs.

A further advantage of this process is that one or more further layers may be applied onto a first elastomer layer. Oversintering onto a first polyurethane layer is also possible.

The inventive fusing of thermoplastic elastomer powders by electromagnetic irradiation with said frequencies, in particular such elastomer powders made of thermoplastic polyurethane, represents a completely novel mode of production of compact elastomers too.

In a preferred embodiment the powder is based on an elastomer that absorbs electromagnetic radiation as a result of its chemical structure.

Preferred thermoplastic elastomer powders include those based on thermoplastic polyurethane (TPU), thermoplastic polyester elastomer, preferably polyetherester and/or polyesterester, thermoplastic copolyamides, preferably thermoplastic styrene or butadiene block copolymers.

Preferred thermoplastic elastomers further include those based on thermoplastic polyurethane (TPU), thermoplastic polyester elastomer, preferably selected from the group of polyetherester and polyesterester, and thermoplastic copolyamides, preferably selected from the group of polyetheramide and polyesteramide.

Preferred elastomers yet further include polyamide 12, polyamide 6/12 and polyamide 12/12.

Particularly preferred are elastomers based on thermoplastic polyurethane (TPU).

In one preferred embodiment thermoplastic elastomer, preferably thermoplastic polyurethane, is used without a coating or addition of an electromagnetic radiation-absorbing additive.

The thermoplastic elastomers preferably have a Shore hardness in the range from 30 A to 78 D.

Since for example in the case of powder sintering the absorption may need to occur very rapidly it is often necessary to employ additional absorbers which in the case of TPU also improve microwave absorption and reduce the required processing time for this material too.

### TPU Chemistry

Thermoplastic polyurethanes are well known. Production is carried out by reaction of (a) isocyanates with (b) isocyanate-reactive compounds/polyol having a number-average molecular weight of 0.5×10³ g/mol to 100×10³ g/mol and optionally (c) chain extenders having a molecular weight of 0.05×10³ g/mol to 0.499×10³ g/mol optionally in the presence of (d) catalysts and/or (e) customary auxiliaries and/or additives. The components (a) isocyanate, (b) isocyanate-reactive compounds/polyol, (c) chain extenders are also referred to, individually or collectively, as synthesis components. The synthesis components including the catalyst and/or the customary auxiliaries and/or additives are also referred to as input materials.

In order to adjust the hardness and melt index of the TPU the employed amounts of synthesis components (b) and (c) may be varied in their molar ratios where hardness and melt viscosity increase with increasing content of chain extender (c) while melt index decreases.

To produce relatively soft thermoplastic polyurethanes, for example those having a Shore A hardness of less than 95, preferably of 95 to 75 Shore A, the essentially difunctional polyols (b) also referred to as polyhydroxyl compounds (b) and the chain extenders (c) may preferably be used advantageously in molar ratios of 1:1 to 1:5, preferably 1:1.5 to 1:4.5, so that the resulting mixtures of the synthesis components (b) and (c) have a hydroxyl equivalent weight of greater than 200, and especially of 230 to 450, while to produce relatively hard TPUs, for example those having a Shore A hardness of greater than 98, preferably of 55 Shore D to 75 Shore D, the molar ratios of (b):(c) are in the range from 1:5.5 to 1:15, preferably from 1:6 to 1:12, so that the obtained mixtures of (b) and (c) have a hydroxyl equivalent weight of 110 to 200, preferably of 120 to 180.

To produce the TPUs according to the invention the synthesis components (a), (b), and in a preferred embodiment also (c), are reacted preferably in the presence of a catalyst (d) and optionally auxiliaries and/or additives (e) in amounts such that the equivalence ratio of NCO groups of the diisocyanates (a) to the sum of the hydroxyl groups in the components (b) and (c) is 0.95 to 1.10:1, preferably 0.98 to 1.08:1 and in particular approximately 1.0 to 1.05:1.

Preferably produced according to the invention are TPUs where the TPU has a weight-average molecular weight of at least 0.1×10⁶ g/mol, preferably of at least 0.4×10⁶ g/mol and in particular more than 0.6×10⁶ g/mol. The upper limit for the weight-average molecular weight of the TPUs is generally determined by the processability, and also the spectrum of properties desired. The number-average molecular weight of the TPUs is preferably not more than 0.8×10⁶ g/mol. The average molecular weights reported hereinabove for the TPU as well as for the synthesis components (a) and (b) are weight averages determined by gel permeation chromatography.

Preferably employed organic isocyanates (a) are aliphatic, cycloaliphatic, araliphatic and/or aromatic isocyanates, more preferably tri-, tetra-, penta-, hexa-, hepta- and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4-bis(isocyanatomethyl)cyclohexane and/or 1,3-bis(isocyanatomethyl)cyclohexane (HXDI), 2,4-paraphenylene diisocyanate (PPDI), 2,4-tetramethylenexylene diisocyanate (TMXDI), 4,4′-, 2,4′- and 2,2′-dicyclohexylmethane diisocyanate (H12 MDI), 1,6-hexamethylene diisocyanate (HDI), 1,4-cyclohexane diisocyanate, 1-methyl-2,4- and/or -2,6-cyclohexane diisocyanate, 2,2′-, 2,4′- and/or 4,4′-diphenylmethane diisocyanate (MDI), 1,5-naphthylene diisocyanate (NDI), 2,4- and/or 2,6-tolylene diisocyanate (TDI), diphenylmethane diisocyanate, 3,3′-dimethyldiphenyl diisocyanate, 1,2-diphenylethane diisocyanate and/or phenylene diisocyanate.

It is preferable to employ the isocyanates 2,2′-, 2,4′- and/or 4,4′-diphenylmethane diisocyanate (MDI), 1,6-hexamethylene diisocyanate (HDI) and 4,4′-, 2,4′- and 2,2′-dicyclohexylmethane diisocyanate (H12 MDI), 4,4′-diphenylmethane diisocyanate (4,4′-MDI) being particularly preferred.

Preferred isocyanate-reactive compounds b) are those having a molecular weight between 500 g/mol and 8×10³ g/mol, preferably 0.7×10³ g/mol to 6.0×10³ g/mol, in particular 0.8×10³ g/mol to 4.0×10³ g/mol.

The isocyanate-reactive compound (b) has on statistical average at least 1.8 and at most 3.0 Zerewitinoff-active hydrogen atoms, this number also being referred to as the functionality of the isocyanate-reactive compound (b) and indicating the amount of isocyanate-reactive groups in the molecule theoretically calculated for one molecule from an amount of substance. The functionality is preferably between 1.8 and 2.6, more preferably between 1.9 and 2.2 and in particular 2.

The isocyanate-reactive compound is substantially linear and is one isocyanate-reactive substance or a mixture of different substances, in which case the mixture then meets the recited requirement.

These long-chain compounds are employed in an amount of substance ratio of 1 equivalent mol % to 80 equivalent mol % based on the isocyanate group content of the polyisocyanate.

It is preferable when the isocyanate-reactive compound (b) has a reactive group selected from the hydroxyl group, the amino group, the mercapto group or the carboxylic acid group. The hydroxyl group is preferred. It is particularly preferable when the isocyanate-reactive compound (b) is selected from the group of polyesterols, polyetherols or polycarbonate diols which are also covered by the umbrella term “polyols”.

Especially preferred are polyester diols, preferably polycaprolactone and/or polyether polyols, preferably polyether diols, more preferably those based on ethylene oxide, propylene oxide and/or butylene oxide, preferably polypropylene glycol. A particularly preferred polyether is polytetrahydrofuran (PTHF), in particular polyetherols. It is particularly preferable to choose polyols such as those from the following group comprising: copolyesters based on adipic acid, succinic acid, pentanedioic acid, sebacic acid or mixtures thereof and mixtures of 1,2-ethanediol and 1,4-butanediol, copolyesters based on adipic acid, succinic acid, pentanedioic acid, sebacic acid or mixtures thereof and mixtures of 1,4-butanediol and 1,6-hexanediol, polyesters based on adipic acid, succinic acid, pentanedioic acid, sebacic acid or mixtures thereof and 3-methyl-1,5-pentanediol and/or polytetramethylene glycol (polytetrahydrofuran, PTHF). Particular preference is given to the use of the copolyester based on adipic acid and mixtures of 1,2-ethanediol and 1,4-butanediol or of the copolyester based on adipic acid and 1,4-butanediol and 1,6-hexanediol or of the polyester based on adipic acid and polytetramethylene glycol (polytetrahydrofuran PTHF) or mixtures thereof.

It is very particularly preferable to use as the polyols polyesters based on adipic acid and polytetramethylene glycol (PTHF) or mixtures thereof.

In preferred embodiments chain extenders (c) are employed; these are preferably aliphatic, araliphatic, aromatic and/or cycloaliphatic compounds having a molecular weight of 0.05×10³ g/mol to 0.499×10³ g/mol and preferably having 2 isocyanate-reactive groups which are also referred to as functional groups.

It is preferable when the chain extender (c) is at least one chain extender selected from the group consisting of 1,2-ethylene glycol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. Chain extenders selected from the group consisting of 1,2-ethylene glycol, 1,3-propanediol, 1,4-butanediol and 1,6-hexanediol are particularly suitable. Very particularly preferred chain extenders are 1,4-butanediol, 1,6-hexanediol and ethanediol.

In preferred embodiments catalysts (d) are employed with the synthesis components. These are in particular catalysts which accelerate the reaction between the NCO groups of the isocyanates (a) and the hydroxyl groups of the isocyanate-reactive compound (b) and, if employed, the chain extender (c). Preferred catalysts are tertiary amines, in particular triethylamine, dimethylcyclohexylamine, N-methylmorpholine, N,N′-dimethylpiperazine, 2-(dimethylaminoethoxy)ethanol, diazabicyclo-(2,2,2)-octane. In another preferred embodiment the catalysts are organic metal compounds such as titanate esters, iron compounds, preferably iron(III) acetylacetonate, tin compounds, preferably those of carboxylic acids, particularly preferably tin diacetate, tin dioctoate, tin dilaurate, or tin dialkyl salts, more preferably dibutyl tin diacetate, dibutyl tin dilaurate, or bismuth salts of carboxylic acids, preferably bismuth decanoate. Particularly preferred catalysts are tin dioctoate, bismuth decanoate, titanate esters.

The catalyst (d) is preferably employed in amounts of 0.0001 to 0.1 parts by weight per 100 parts by weight of the isocyanate-reactive compound (b).

Not only catalysts (d) but also customary auxiliaries (e) may be added to the synthesis components (a) to (c). Examples include surface-active substances, fillers, flame retardants, nucleating agents, oxidation stabilizers, lubricating and demolding auxiliaries, dyes and pigments, optionally stabilizers, preferably against hydrolysis, light, heat or discoloration, inorganic and/or organic fillers, reinforcing agents and/or plasticizers.

In the context of the present invention stabilizers are additives which protect a plastic or a plastics mixture against damaging environmental influences. Examples include primary and secondary antioxidants, sterically hindered phenols, hindered amine light stabilizers, UV absorbers, hydrolysis stabilizers, quenchers and flame retardants. Examples of commercial stabilizers may be found in Plastics Additives Handbook, 5th Edition, H. Zweifel, ed., Hanser Publishers, Munich, 2001 ([1]), pages 98-136.

In a preferred embodiment the UV absorbers have a number-average molecular weight of greater than 0.3×10³ g/mol, in particular greater than 0.39×10³ g/mol. Furthermore the preferably employed UV absorbers should have a molecular weight of not more than 5×10³ g/mol, particularly preferably of not more than 2×10³ g/mol.

Particularly suitable UV absorbers are the group of benzotriazoles. Examples of particularly suitable benzotriazoles are Tinuvin® 213, Tinuvin® 234, Tinuvin® 571 and also Tinuvin® 384 and Eversorb®82. The UV absorbers are typically added in amounts of 0.01% by weight to 5% by weight based on the total mass of TPU, preferably 0.1% by weight to 2.0% by weight, in particular 0.2% by weight to 0.5% by weight.

An above-described UV stabilization based on an antioxidant and a UV absorber is often not yet sufficient to ensure a good stability of the TPU according to the invention against the damaging effect of UV radiation. In this case a hindered amine light stabilizer (HALS) may still be added to the TPU according to the invention in addition to the antioxidant and the UV absorber. The activity of the HALS compounds is based on their ability to form nitroxyl radicals which interferes in the mechanism for oxidation of polymers. HALS are highly efficient UV stabilizers for most polymers.

HALS compounds are common knowledge and commercially available. Examples of commercially available HALS stabilizers may be found in Plastics Additives Handbook, 5th edition, H. Zweifel, Hanser Publishers, Munich, 2001, pages 123-136.

Preferably employed hindered amine light stabilizers are hindered amine light stabilizers having a number-average molecular weight greater than 500 g/mol. Furthermore, the preferred HALS compounds should have a molecular weight of not more than 10×10³ g/mol, particularly preferably not more than 5×10³ g/mol.

Particularly preferred hindered amine light stabilizers are bis-(1,2,2,6,6-pentamethylpiperidyl) sebacate (Tinuvin® 765, Ciba Spezialitätenchemie AG) and the condensation product of 1-hydroxyethyl-2,2,6,6-tetramethyl-4-hydroxypiperidine and succinic acid (Tinuvin® 622). Especially preferred is the condensation product of 1-hydroxyethyl-2,2,6,6-tetramethyl-4-hydroxypiperidine and succinic acid (Tinuvin® 622) when the titanium content of the finished product is less than 150 ppm, preferably less than 50 ppm, in particular less than 10 ppm, based on the employed synthesis components.

HALS compounds are preferably employed in a concentration of 0.01% by weight to 5% by weight, particularly preferably of 0.1% by weight to 1% by weight, in particular of 0.15% by weight to 0.3% by weight, based on the total weight of the thermoplastic polyurethane based on the employed synthesis components.

A particularly preferred UV stabilization comprises a mixture of a phenolic stabilizer, a benzotriazole and a HALS compound in the above-described preferred amounts.

Further details concerning the abovementioned auxiliaries and additives may be found in the technical literature, for example in Plastics Additives Handbook, 5th edition, H. Zweifel, ed., Hanser Publishers, Munich, 2001.

The TPUs may be produced discontinuously or continuously by the known processes, for example using reactive extruders or the belt process by the “one-shot” process or the prepolymer process, preferably by the “one-shot” process. In the “one-shot” process the to-be-reacted components (a), (b), and in preferred embodiments also the components (c), (d) and/or (e), are mixed with one another consecutively or simultaneously, resulting in immediate commencement of the polymerization reaction. In the extruder process the synthesis components (a), (b), and in preferred embodiments also (c), (d) and/or (e), are introduced into the extruder individually or as a mixture and brought to reaction preferably at temperatures of 100° C. to 280° C., preferably 140° C. to 250° C. The obtained polyurethane is extruded, cooled and pelletized.

It is preferable to use for the production of the thermoplastic polyurethane a twin-screw extruder since the twin-screw extruder is positively conveying, thus allowing more precise adjustment of temperature and output quantity on the extruder.

The elastomers used are in the form of powder. All customary pulverization technologies and grinding techniques, such as micropelletization, grinding, cryogenic grinding, precipitation, melt dispersion may be employed in this case to generate powder from the starting materials which are preferably in the form of pellet material. In a preferred embodiment cryogrinding and micropelletization are used, particularly preferably micropelletization. These powders have a particularly smooth surface and therefore show better flow characteristics and fewer air inclusions in the molding which manifests in improved mechanical properties, in particular an improved breaking extension and tensile strength of the test specimens.

In preferred embodiments the powders have a maximum spatial extent in the range from 1 μm to 3 mm, preferably from 50 μm to 2 mm, and particularly preferably of 200 μm to 1.0 mm.

In a preferred embodiment the powder has a poured density in the range from 200 kg/m³ to 900 kg/m³.

In a further preferred embodiment the powder based on thermoplastic elastomer comprises at least one additive that absorbs the electromagnetic radiation. The absorption of the electromagnetic radiation heats to melting point primarily the additives but thus also the powder made of the thermoplastic elastomer which comprises said additives.

In a further preferred embodiment the proportion of the microwave-absorbing additive is 0.01% by weight to 30% by weight, preferably 0.01% by weight to 10% by weight, particularly preferably 0.01% by weight to 5% by weight, based on the total powder. In a preferred embodiment the additive that absorbs electromagnetic radiation is mixed with the thermoplastic elastomer and in another preferred embodiment the elastomer in the powder is at least partially surrounded by a coating comprising the additive that absorbs the electromagnetic radiation.

The invention therefore also provides a process for producing the powders according to the invention in which the thermoplastic elastomer is mixed with the additive that absorbs electromagnetic radiation or in that the elastomer is at least partially coated with the additive, i.e. a coating is applied to the elastomer powder.

These additives are preferably applied to the polyurethane powder in the form of pure material, a solution, a powder or a dispersion with customary mixing processes and coating processes, such as spraying, immersion or wetting with or without additional auxiliaries. Preferably employed to this end are mixers, spraying apparatuses, immersion apparatuses/drum apparatuses.

It is particularly preferable when the elastomer powder is enriched with a plasticizer that absorbs the electromagnetic radiation or is coated with an emulsion of a substance that absorbs the electromagnetic radiation in a plasticizer.

Examples of plasticizers include: phthalates, alkylsulfonate esters, citrate esters, adipate esters, diisononyl 1,2-cyclohexanedicarboxylate and glycerol esters.

In the process according to the invention for producing the powder the particle surfaces are initially thinly coated with the strongly microwave-absorbing substance in, for example, a tumbling mixer. The thus-coated powder is placed in a mold which is nonabsorbing for the electromagnetic radiation and subsequently welded by irradiation with the electromagnetic radiation. The additive is preferably a highly polar liquid compound such as glycerol triacetate, triethylene or tripropylene glycol or citrate ester. Glycerol triacetate, triethylene or tripropylene glycol and citrate ester are particularly preferred.

The additive absorbs electromagnetic radiation and thus effects specific heating of the contact points of the powder so that these are welded. Due to their solubility the substances are uniformly distributed in the polymer after a short time and are kept stable therein. If additional absorbers are eschewed sufficiently polar polymers may likewise be welded by suitable high-frequency radiation (MW) but the required heating time is longer and the achieved temperature may be lower.

It is particularly preferable when the thermoplastic powders are enriched with a 1,2,3-propanetriol triacetate (triacetin).

In a preferred embodiment the coating is based on a substance which has a boiling point above 120° C. and is soluble in the elastomer.

In a further preferred embodiment the additive that absorbs the electromagnetic radiation is selected from the group comprising glycerol triacetate, triethylene glycol, tripropylene glycol or citrate ester. In one embodiment only one additive that absorbs electromagnetic radiation is present and in another embodiment at least two such additives are present in the powder.

In another preferred embodiment the elastomer powder is prior to irradiation mixed with a colored pigment typically having a maximum particle size of 5 μm to 10 μm or with a liquid dye.

In a further preferred process the colored pigment is inhomogeneously mixed with the elastomer powder. This results in layers having different mechanical properties. Different coloring may also be achieved.

In another preferred embodiment the powder is applied in at least two different layers with different coloring. Here too the mechanics may be influenced through suitable choice of pigments. An appropriate choice of pigments may also be used to determine the optical configuration of the molded element.

The present invention further provides a molding obtainable by one of the described processes preferably having a breaking elongation greater than 100%, more preferably of more than 200%.

The present invention further provides for the use of the moldings produced according to the invention for visible components in automobiles, artificial leather, bags, packagings, boots, shoes, shoe soles, furnishings, furniture. Preferred visible components in automobiles are steering wheels, shift knobs and handles.

The invention further provides for the use of the powder according to the invention for the production of hollow bodies, preferably by the rotational sintering process. In a preferred embodiment the mold rotates in a microwave, in another preferred embodiment a microwave transmitter is built into the rotational mold. The invention likewise provides the process itself in conjunction with all intimated process parameters.

In another preferred embodiment fibers, preferably those made of plastic, glass and/or metal, are placed in the thermoplastic powder and after processing form their own network inside the component parts. This can result in improved mechanical properties of the molding.

The invention further provides a process for producing moldings by joining the thermoplastic elastomer powder by means of electromagnetic radiation in a frequency range between 0.01 GHz and 300 GHz, preferably in the frequency range between 0.01 GHz and 100 GHz, more preferably between 0.1 GHz and 50 GHz, more preferably the electromagnetic radiation is used on the powder for between 0.1 and 15 minutes.

In a preferred embodiment of this process the thermoplastic elastomer powders according to the invention are placed in a mold nonabsorbing for microwave radiation and therein microwave-welded.

The invention further provides elastomers obtainable by the process described hereinabove.

It is preferable when the elastomers used for producing moldings are selected from the group comprising coatings, damping elements, bellows, films, fibers, molded articles, floors for buildings or transport, nonwovens, seals, rollers, shoe soles, hoses, cables, cable plugs, cable sheathings, cushions, laminates, profiles, belts, saddles, foams, by additional foaming of the preparation, union connectors, two cables, solar modules, trim in automobiles, wiper blades.

Each of these uses taken by itself is a preferred embodiment also described as an application.

### EXAMPLES

### 1. Example—Input Materials and Production

TPU powder: thermoplastic polyurethane obtained from pelletized thermoplastic polyurethane from BASF Polyurethanes GmbH, Lemförde, Germany
Microwave absorber: Triacetin (1,2,3-propanetriol triacetate)

### Formulation of Thermoplastic Polyurethanes (TPU)

TABLE 1
starting substances for producing the thermoplastic polyurethanes

| Name | Chemical composition | Source |
|---|---|---|
| Iso1 | 1,6-hexane diisocyanate | BASF |
| Iso2 | 4,4′-methylenediphenylene diisocyanate | BASF |
| Polyol1 | polytetrahydrofuran, Mn: 1000, OH number: 111.1 | BASF |
| Polyol2 | polyester diol, Mn: 2200, OH number: 51 | BASF |
| KV1 | 1,4-butanediol, chain extender | BASF |
| KV2 | 1,6-hexanediol, chain extender | BASF |
| AO1 | Antioxidant | BASF |
| AO2 | Antioxidant | BASF |
| LS1 | Photoprotective agents | BASF |
| HS1 | carbodiimide hydrolysis stabilizer | BASF |
| FL1 | Talc filler | |
| GL1 | wax processing aid | |

TPU 1 formulation

| Name | Amount | Unit |
|---|---|---|
| Polyol1 | 6920 | KG |
| Iso1 | 1861 | KG |
| KV2 | 920 | KG |
| AO1 | 45 | KG |
| HS1 | 69 | KG |
| AO2 | 50 | KG |
| GL1 | 20 | KG |
| LS1 | 100 | KG |
| FL1 | 15 | KG |

TPU 2 formulation

| Name | Amount | Unit |
|---|---|---|
| Polyol2 | 5601 | KG |
| Iso2 | 3528 | KG |
| KV1 | 766 | KG |
| AO2 | 100 | KG |
| GL1 | 5 | KG |

### Production of the Polymers in Manual Casting Process

The polyols were initially charged in a container at 80° C. and mixed by vigorous stirring with the components according to the abovementioned formulations in a batch size of 2 kg. The reaction mixture underwent heating to over 110° C. and was then poured out onto a Teflon-coated table heated to about 110° C. The obtained casting was heat-treated at 80° C. for 15 hours and then subjected to coarse comminution and extruded to afford pellet material.

Extrusion was carried out in a twin-screw extruder affording an extrudate diameter of about 2 mm.

| | |
|---|---|
| Extruder: | Corotating APV MP19 twin-screw extruder |
| Temperature profile: | HZ1 (feed zone) 175° C. to 185° C. |
| | HZ2 180° C. to 190° C. |
| | HZ3 185° C. to 195° C. |
| | HZ4 185° C. to 195° C. |
| | HZ5 (die) 180° C. to 190° C |
| Screw speed: | 100 rpm |
| Pressure: | about 10 to 30 bar |
| Extrudate cooling: | water bath (10° C.) |

Micropellet materials were produced in a Berstorff ZE 40 twin-screw extruder fitted with a micro-hole plate and an underwater micropelletizer from Gala.

The powder grinding was carried out in a Retsch ZM200 mill fitted with different sieve inserts of 0.35 mm, 1 mm and 2 mm with dry ice or N2 cooling and sieving-out of the fractions described in the examples.

### 2. Example—Instruments

MLS-Ethos plus laboratory microwaves system having a maximum output of 2.5 kW.

### 3. Example—Methods of Measurement

### 3.1 Particle Size: Determination Using Micrographs

### 3.2 Poured Density

To determine poured density a 700 ml vessel was filled with the powder and the weight was determined using a balance. Accuracy is ±10 g/I.

### 3.3 Density

Density was determined according to the version of standard DIN EN ISO 1183-1, A current at the date of filing.

### 3.4 Breaking Elongation and Tensile Strength

Breaking elongation and tensile strength were determined according to the version of standard DIN 53504-S2 current at the date of filing.

### 3.5 Shore a Hardness

Shore A hardness was determined according to the version of standard DIN ISO 7619-1 current at the date of filing

### 3.6 Abrasion

Abrasion was determined according to the version of standard DIN ISO 4649 current at the date of filing.

### 4. Example—Inventive Example B1

The TPU 1 was manufactured in a particle size of less than 500 μm by underwater pelletization (micropellet powder). The poured density of this micropellet powder is 660 g/L. In each case 15 g of the powder were uniformly distributed in Teflon molds having dimensions of 100 mm×70 mm and irradiated in the microwave for 2 minutes at an output of 700 W. In order to achieve homogeneous microwave irradiation the molds were rotated on a turntable during irradiation. In addition the individual molds were manually rotated 180° around their horizontal axis after 1 min. After 2 minutes the powder had sintered together to afford a sheet. After a short cooling phase of 3 minutes in room-temperature air of about 20° C. the sheets were removed from the molds. Simultaneously with these test sheets for tensile and breaking strength testing having dimensions of 700 mm×70 mm×2 mm, 6 g of powder were in each case used to produce sheets having dimensions of 35 mm×35 mm×6 mm for determining density, shore hardness and abrasion.

### 5. Example—Inventive Example B2

The TPU 1 pellet material was ground to a particularly small particle size of less than 165 μm in a cryogenic pin mill. The poured density of this powder is 470 g/L. In each case 15 g of the powder were uniformly distributed in Teflon molds having dimensions of 100 mm×70 mm and irradiated in the microwave for 2 minutes at an output of 700 W. In order to achieve homogeneous microwave irradiation the molds were rotated on a turntable during irradiation and in addition the individual molds were manually rotated 180° around their horizontal axis after 1 min. After 2 minutes the powder had sintered together to afford a sheet. After a short cooling phase of 3 minutes in room-temperature air of about 20° C. the sheets were removed from the molds. Simultaneously with these test sheets for tensile and breaking strength testing having dimensions of 700 mm×70 mm×2 mm, 6 g of powder were in each case used to produce sheets having dimensions of 35 mm×35 mm×6 mm for determining density, shore hardness and abrasion.

### 6. Example—Inventive Example B3

The TPU 2 was manufactured in a particle size of less than 500 μm by underwater pelletization. The poured density of this powder was 700 g/L. In each case 15 g of the powder were uniformly distributed in Teflon molds having dimensions of 100 mm×70 mm and irradiated in the microwave for 2 minutes at an output of 700 W. In order to achieve homogeneous microwave irradiation the molds were rotated on a turntable during irradiation and in addition the individual molds were manually rotated 180° around their horizontal axis after 1 min. After 2 minutes the powder had sintered together to afford a sheet. After a short cooling phase of 3 minutes in room-temperature air of about 20° C. the sheets were removed from the molds. Simultaneously with these test sheets for tensile and breaking strength testing having dimensions of 700 mm×70 mm×2 mm, 6 g of powder were in each case used to produce sheets having dimensions of 35 mm×35 mm×6 mm for determining density, shore hardness and abrasion.

### 7. Example—Example B4 Preferred According to the Invention

The TPU 1 was manufactured in a small particle size of less than 500 μm by underwater pelletization. The poured density of this powder was 660 g/L. This powder was enriched with 3% by weight of triacetin. The addition was effected by addition of 3 g of triacetin to 97 g of powder which was fully mixed in over 4 hours in a closed vessel on an electric roller belt. In each case 15 g of this powder were uniformly distributed in Teflon molds having dimensions of 100 mm×70 mm and irradiated in the microwave at an output of 700 W. In order to achieve homogeneous microwave irradiation the molds were rotated on a turntable during irradiation and in addition the individual molds were manually rotated 180° around their horizontal axis after 1 min. After only 90 seconds the triacetin-comprising powder had sintered together to afford a sheet. After a short cooling phase of 3 minutes in room-temperature air the sheets were removed from the molds. Simultaneously with these test sheets for tensile and breaking strength testing having dimensions of 700 mm×70 mm×2 mm, 6 g of powder were in each case used to produce sheets having dimensions of 35 mm×35 mm×6 mm for determining density, shore hardness and abrasion.

### 8. Example—Comparative Test V1

The comparative specimen V1 was manufactured according to the common knowledge injection molding process. The base material used was TPU 1. Testing was carried out on injection molded sheets having thicknesses of 2 mm and of 6 mm. The test sheets were heat-treated at 80° C. for 20 hours to improve the mechanical properties. Sheets produced by injection molding achieve optimal mechanical properties and serve as a reference for the mechanical properties in the process according to the invention:

### 9. Example—Comparative Test V2

The comparative specimen V2 was produced in the powder slush process. The base material used was TPU 1 which was in pulverulent form with a particle size of less than 500 μm. The powder was placed on a 230° C. metal mold, which had been preheated in a circulating air oven for 45 minutes, and was subsequently stored in a heating cabinet having a temperature of 240° C. until complete melting of the powder. 2 minutes were required to melt 100 g of powder having an initial height of 3 mm. The melting of 70 g of powder having an initial height of 10 mm required 4 minutes.

The metal molds were subsequently cooled to room temperature over 5 minutes in a water bath. The melt solidified during cooling and was removable in the cold state. Testable sheets having thicknesses of 2 mm and 6 mm were produced.

The samples produced by the customary powder slush process required about one hour to produce a molding while, by contrast, by the sintering process described here moldings are obtainable after only a few minutes.

### 10. Example—Results

The properties of the elastomer sheets from the examples of B1 to B4 and the comparative tests V1-V2 are summarized in table 1.

In all properties the materials described in the inventive examples B1 to B4 achieved the high level of comparative example 1, the standard TPU, which was produced in an injection molding machine in the customary process and for further improvement of the mechanical properties was heat treated in a circulating air oven at 80° C. for 20 hours. The materials sintered by microwave radiation are likewise of equivalent quality to comparative example 2, the powder slush process, and the production times are only a fraction of those of the known powder slush process.

The use of triacetin in example B4 allows a time saving over B1 during processing and the values for tensile strength, breaking elongation and abrasion remain comparable.

TABLE 1
Properties of the elastomer sheets

| | B1 | B2 | B3 | B4 | V1 | V2 |
|---|---|---|---|---|---|---|
| Density [g/l] | 1.13 | 1.12 | 1.11 | 1.13 | 1.14 | 1.13 |
| Shore hardness | 93 | 93 | 88 | 92 | 90 | 93 |
| Tensile | 13 | 10 | 12 | 12 | 15 | 13 |
| strength [MPa] | | | | | | |
| Breaking | 700 | 510 | 730 | 630 | 640 | 730 |
| elongation | | | | | | |
| [MPa] | | | | | | |
| Abrasion | 116 | 198 | 170 | 132 | 118 | 117 |

1-21. (canceled)

22: A process for producing a molding from a powder based on a thermoplastic elastomer, the process comprising:
placing the powder on or in a mold, and
heating the powder with electromagnetic radiation, wherein a frequency of the electromagnetic radiation is between 0.01 and 100 GHz, such that the powder undergoes at least partial melting and fuses, to obtain the molding.

23: The process of claim 22, wherein the powder comprises:
an elastomer that absorbs the electromagnetic radiation as a result of its chemical structure and/or
at least one additive that absorbs the electromagnetic radiation.

24: The process of claim 23, wherein the elastomer is selected from the group consisting of a thermoplastic polyurethane (TPU), a thermoplastic polyester elastomer and a thermoplastic copolyamide.

25: The process of claim 24, wherein the thermoplastic polyester elastomer is selected from the group consisting of a polyetherester and a polyesterester and/or the thermoplastic copolyamide is selected from the group consisting of a polyetheramide and a polyesteramide.

26: The process of claim 22, wherein the elastomer is a thermoplastic polyurethane.

27: The process of claim 22, wherein an individual region of the molding is specifically heated with a maser or a targeted electromagnetic beam having a frequency between 0.01 GHz and 100 GHz.

28: The process of claim 27, wherein the powder is mixed with a pigment or a liquid dye prior to the heating.

29: The process of claim 28, wherein the pigment is inhomogeneously mixed with the powder and/or the powder is applied in at least two layers with different coloring.

30: The process of claim 22, wherein the molding is a hollow body produced by a rotational sintering process and the mold rotates in an electromagnetic radiation-emitting device or electromagnetic radiation is emitted inside a rotating mold by an antenna.

31: The process of claim 23, wherein the additive is glycerol triacetate, triethylene glycol, tripropylene glycol or citrate ester.

32: The process of claim 31, wherein the powder is produced by micropelletization.

33: The process of claim 31, wherein a maximum spatial extent of the powder is 200 μm to 1.0 mm.

34: The process of claim 31, wherein a total proportion of the elastomer and additive is 0.01% by weight to 30% by weight, based on a total weight of the powder.

35: The process of claim 31, wherein the elastomer is at least partially surrounded by a coating comprising the additive.

36: The process of claim 35, wherein the coating is based on a substance which has a boiling point above 120° C. and is soluble in the thermoplastic elastomer.

37: The process of claim 35, wherein a weight fraction of the coating is from 1% by weight to 5% by weight, based on a total weight of the powder.

38: The process of claim 31, wherein the powder has a poured density in a range from 200 kg/m³ to 900 kg/m³.

39: The process of claim 31, wherein the thermoplastic elastomer is selected from the group consisting of a thermoplastic polyurethane (TPU), a thermoplastic polyester elastomer and a thermoplastic copolyamide.

40: A molding, obtained by the process of claim 22.

41: A visible component, suitable for an automobile, an artificial leather, a bag, a packaging, a boot, a shoe, a shoe sole, a furnishing or furniture, and comprising the molding of claim 40.
